(19) United States
(12) Patent Application Publication
(10) Pub. No.: US 2018/0358723 A1
(43) Pub. Date: Dec. 13, 2018

(54) PIN HEADER

(71) Applicant: Shenzhen Orico Technologies Co., Ltd., Shenzhen (CN)

(72) Inventor: Yeyou Xu, Shenzhen (CN)

(21) Appl. No.: 16/078,928

(22) PCT Filed: Nov. 29, 2016
(86) PCT No.: PCT/CN2016/107741

§ 371 Date: Aug. 22, 2018

(30) Foreign Application Priority Data
Sep. 13, 2016 (CN) 201610820766.3

(51) Int. Cl. H01R 12/53; H01R 4/02; H01R 12/55

(52) U.S. Cl. CPC H01R 12/53; H01R 12/55; H01R 4/028; H01R 4/023

(57) ABSTRACT

Provided is a pin header (100). The pin header (100) comprises an insulation body (10) and a plurality of pins (30) arranged at intervals. A portion of each pin (30) is fixed to the insulation body (10). Each pin (30) comprises a wire connection portion (31). A welding platform (11) is formed at a surface of the insulation body (10). A plurality of wire connection portions (31) are fixed to a platform surface (111) of the welding platform (11). The pin header (100) aims to realize mechanical automation of a welding operation between a wire and a wire connection portion (31) thereof, thereby improving productivity, and reducing labor costs.

### TECHNICAL FIELD

The present disclosure relates to a pin header.

### BACKGROUND OF THE INVENTION

Nowadays, as a kind of connector, pin headers are widely used in PCBs (printed circuit board) of devices such as electronics, electrics, instruments and so on. They serve as a bridge at a blockade in a circuit or between isolated and blocked circuits to realize the transmission of current or signals. At present, for the connection between a wire and a PCB, pin headers are also widely used because of their unique advantages. However, at present, most of the pin headers that are used for the connection between a wire and a PCB generally have a structural defect that wire connection portions of some pins all extend vertically from the surface of the insulation body and are suspended, and as a result, soldering between the wire and the wire connection portion of the pin header can only be performed manually, leading to extremely low productivity.

### SUMMARY OF THE INVENTION

A main object of the present disclosure is to provide a pin header, in order to realize mechanical automation of a soldering operation between a wire and a wire connection portion of the pin header, thereby improving productivity and reducing labor costs.

In order to achieve the above object, the pin header provided by the present disclosure comprising an insulation body and a plurality of pins arranged at intervals, wherein a portion of each pin is fixed to the insulation body, each pin comprises a wire connection portion, a soldersoldering platform is formed at a surface of the insulation body, and a plurality of wire connection portions are all fixed to a platform surface of the soldering platform.

Optionally, a plurality of the wire connection portions are parallel to each other.

Optionally, the platform surface is formed with a plurality of soldering grooves arranged at intervals, and each wire connection portion is correspondingly fixed to one soldering groove.

Optionally, a width of each wire connection portion is the same as a width of the corresponding soldering groove.

Optionally, a height of each wire connection portion is smaller than a height of the corresponding soldering groove.

Optionally, an end surface of each wire connection portion facing away from a bottom of the corresponding soldering grooves is in a same plane.

Optionally, each wire connection portion has a rectangular section, and each wire connection portion is caught in a corresponding soldering groove.

Optionally, the soldering platform is plural in number, and the platform surface of each soldering platform is respectively fixed with a plurality of wire connection portions.

Optionally, each pin further comprises one plate connection portion, a plurality of plate connection portions protrude from the surface of the insulation body, and end portions of a plurality of the plate connection portions extend toward to a same direction.

In the technical solution of the present disclosure, by fixing the wire connection portions of a plurality of pins of the pin header to the platform surface of the soldering platform, the wire connection portion thus can be provided with effective support from the soldering platform when being soldered with a wire, and then the impact resistance of each wire connection portion in a direction perpendicular to its extending direction can be improved, which solves the problems of bending, deformation or even fracture in the wire connection portion of an existing pin header at the time of performing automatic soldering between the wire connection portion and the wire by a mechanical arm, effectively completes the automatic soldering work of the mechanical arm, and ensures the soldering quality, and accordingly, mechanical automation of a soldering operation between the wire and the wire connection portion of the pin header can be realized, thereby improving productivity and reducing labor costs.

### BRIEF DESCRIPTION OF THE DRAWINGS

In order to more clearly illustrate the technical solutions of the embodiments of the present disclosure or in the prior art, brief description is made below on the drawings required to be used in the description of the embodiments or the prior art. Obviously, the following drawings only illustrate some of the embodiments of the present disclosure. For a person of ordinary skills in the art, other drawings may be obtained on the basis of the structures shown in these drawings without inventive effort.

FIG. 1 is a schematic structural diagram of an embodiment of a pin header according to the present disclosure.

### DESCRIPTION OF REFERENCE SIGNS

TABLE 1

| reference sign | name |
|---|---|
| 100 | pin header |
| 10 | insulation body |
| 11 | soldering platform |
| 111 | platform surface |
| 113 | side surface |
| 115 | soldering groove |
| 30 | pin |
| 31 | wire connection |
| | portion |
| 33 | plate connection |
| | portion |

The realization of the object, functional characteristics and advantages of the present disclosure will be further described in connection with the embodiments with reference to the accompanying drawings.

### DESCRIPTION OF THE CURRENT EMBODIMENTS

The technical solutions in the embodiments of the present disclosure will be clearly and completely described below with reference to the drawings of the embodiments of the present disclosure. Obviously, the embodiments described are only some of the embodiments of the present disclosure, rather than all of the embodiments of the present disclosure. All the other embodiments that are obtained by a person of ordinary skills in the art on the basis of the embodiments of the present disclosure without inventive effort shall be covered by the protection scope of the present disclosure.

It is to be noted that, all directional indications (such as “upper”, “lower”, “left”, “right”, “front”, “rear” . . . ) in the embodiments of the present disclosure are only used to explain the relative positional relationship, movement, etc. of various components in a particular attitude (as shown in the drawing), and if the particular attitude changes, the directional indications change accordingly.

In addition, the terms such as “first” and “second” (if present) in the present disclosure merely serve the purpose of description and cannot be understood as an indication or implication of relative importance, or an implication of the number of the technical feature referred to. Therefore, the features defined with the terms “first” and “second” may explicitly or implicitly indicate that there is at least one such feature. In the description of the present disclosure, the term “a plurality of” means at least two, e.g., two, three, etc., unless otherwise specifically defined.

In the present disclosure, unless otherwise explicitly specified and defined, the terms such as “connect” and “fix” shall be understood in broad sense, for example, the term “fix” may refer to fixed connection, detachable connection or integral connection; may refer to mechanical connection or electrical connection; may refer to direct connection or indirect connection by means of an intermediate medium; and may refer to communication between two elements, or interactional relation between two elements, unless otherwise explicitly defined. A person of ordinary skills in the art could understand the specific meaning of the terms in the present disclosure according to specific situations.

In addition, the technical solutions of the various embodiments of the present disclosure can be combined with each other, which, however, must be based on the fact that the combination can be realized by a person of ordinary skills in the art, and when the combination of the technical solutions encounters contradictions or cannot be achieved, it should be deemed that such combination of the technical solutions does not exist, nor is it within the scope of protection of the present disclosure.

The present disclosure proposes a pin header 100 for connection between a wire and a PCB.

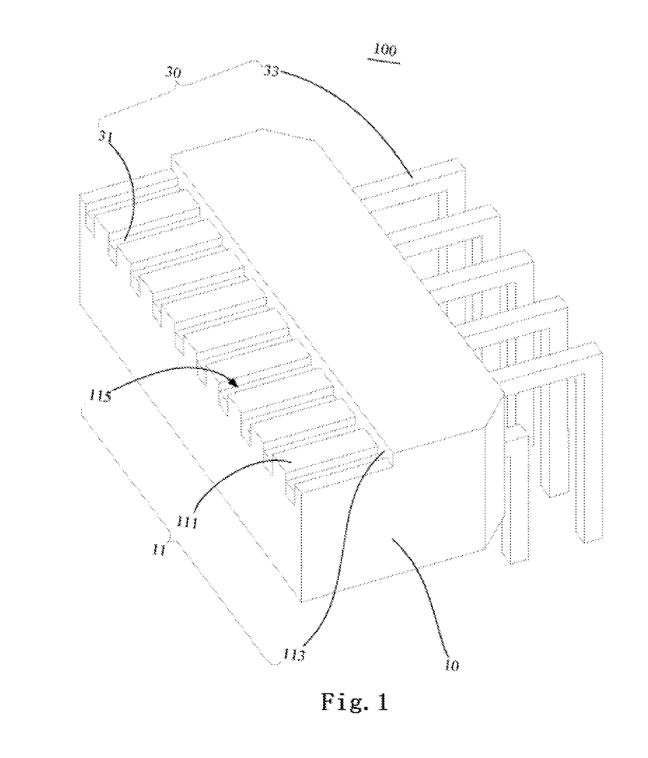

Referring to FIG. 1, in one embodiment of the pin header 100 of the present disclosure, the pin header 100 comprising an insulation body 10 and a plurality of pins 30 arranged at intervals, wherein a portion of each pin 30 is fixed to the insulation body 10, each pin 30 comprises a wire connection portion 31, a soldering platform 11 is formed at a surface of the insulation body 10, and a plurality of wire connection portions 31 are fixed to a platform surface 111 of the soldering platform 11.

In this embodiment, the insulation body 10 is made of an insulating material and has a shape of right prism, and the top surface thereof is sunk to a same depth from the middle to the edge to form a soldering platform 11. The soldering platform 11 comprises a platform surface 111 and a side surface 113. A plurality of the pins 30 all through penetrate the insulation body 10, exposing a plurality of wire connection portions 31 at the junction between the platform surface 111 and the side surface 113 of the soldering platform 11, and a plurality of the wire connection portions 31 are all embedded in the platform surface 111 of the soldering platform 11. Understandably, in other embodiments, the soldering platform 11 may be formed or arranged in other reasonable ways, for example, the soldering platform 11 protrudes from the surface of the insulation body 10; and a plurality the of wire connection portions 31 may be fixed to the platform surface 111 of the soldering platform 11 in other reasonable ways, for example, adhesive bonding, etc.

In the technical solution of the present disclosure, by fixing the wire connection portions 31 of a plurality of pins 30 of the pin header 100 to the platform surface 111 of the soldering platform 11, the wire connection portion 31 can obtain effective support from the soldering platform 11 when being soldered with a wire, and then the impact resistance of each wire connection portion 31 in a direction perpendicular to its extending direction can be improved, which solves the problems of bending, deformation or even fracture in the wire connection portion of an existing pin header at the time of performing automatic soldering between the wire connection portion and the wire by a mechanical arm, effectively completes the automatic soldering work of the mechanical soldering arm, and ensures the soldering quality, and accordingly, mechanical automation of a soldering operation between the wire and the wire connection portion 31 of the pin header 100 can be realized, thereby improving productivity and reducing labor costs.

Preferably, a plurality of the wire connection portions 31 are parallel to each other.

Understandably, when the same number of wire connection portions 31 are arranged, the arrangement in which a plurality of the wire connection portions 31 are parallel to each other can effectively reduce the required area of the platform surface 111 of the soldering platform 11, which then can reduce the volume of the insulation body 10 and ensmall the volume of the pin header 100, thus leaving more area and space for the arrangement of other structures in the PCB and relevant devices applying the pin header 100, so as to accomplish other corresponding functions.

Moreover, such a structural arrangement can also reduce the volume of the relevant devices applying the pin header 100, thereby effectively saving space.

In addition, such a structural arrangement can also facilitate the design and arrangement of the traveling track of the mechanical soldering arm, so as to shorten the duration of soldering between the wire and the wire connection portion 31 of the pin header 100, improve the soldering efficiency, and thereby further improve the productivity.

Referring to FIG. 1, the platform surface 111 is formed with a plurality of soldering grooves 115, a plurality of the soldering grooves 115 are arranged at intervals, and each wire connection portion 31 is correspondingly fixed to one soldering groove 115.

In this embodiment, each wire connection portion 31 corresponds to one soldering groove 115, and is fixed to the groove bottom of the soldering groove 115, so that the process of soldering between each wire connection portion 31 and the corresponding wire can be performed at a relatively independent spatial position, so as to prevent soldering of the wire connection portions 31 on which soldering has not been performed from adversely affecting the wire connection portions on which soldering has been finished, thereby improving the soldering quality.

Preferably, the width of each wire connection portion 31 is the same as the width of the corresponding soldering groove 115.

Understandably, the width of each wire connection portion 31 is the same as the width of the corresponding soldering groove 115, thus enables each wire connection portion 31 to be caught in the corresponding soldering groove 115, so as to further improve the stability of fixing each wire connection portion 31 to the corresponding soldering groove 115, thereby further improving the impact resistance of each wire connection portion 31 and ensuring that the position of the wire connection portion 31 is accurately fixed without deviation during the process of soldering the wire connection portion with the corresponding wire, so as to effectively ensure a smooth soldering process and improve the soldering quality.

Preferably, the height of each wire connection portion 31 is smaller than the height of the corresponding soldering groove 115.

Understandably, such arrangement of the soldering groove 115 can effectively accommodate extra tin solder produced during the soldering process and prevent the extra tin solder from flowing at a high soldering temperature to the adjacent wire connection portion 31 to conduct adjacent wire connection portions 31, thereby preventing short circuit of the device caused by conducting the adjacent wire connection portions 31, and further effectively improving the safety of the device using the pin header 100.

Preferably, end surfaces of the wire connection portions 31 facing away from the bottom of the corresponding soldering grooves 115 are in asame plane, which makes it possible to dispose the end surfaces of the wire connection portions 31 facing away from the bottom of the corresponding soldering grooves 115 in a same horizontal plane, thereby further facilitating the design and arrangement of the traveling track of the mechanical soldering arm, and shortening the traveling track, so as to further shorten the duration of soldering, improve the soldering efficiency, and thereby further improve the productivity.

Preferably, each wire connection portion 31 has a rectangular section, and each wire connection portion 31 is caught in a corresponding soldering groove 115.

In this embodiment, such a structural arrangement can enable the two end surfaces of each wire connection portion 31 facing the two side walls of the corresponding soldering groove 115 to closely abut the two side walls of the corresponding soldering groove 115, so as to further improve the stability of the catching of each wire connection portion 31 in the soldering groove 115, and improve the impact resistance of each wire connection portion 31, thereby further ensuring a smooth soldering process and improving the soldering quality. Specifically, sectional dimensions of each wire connection portion 31 can be unifiedly selected from one of 0.3 mm×0.3 mm, 0.4 mm×0.4 mm, 0.5 mm×0.5 mm, 0.64 mm×0.6 mm, so as to facilitate mass production and selection of the pins 30.

In addition, the end surface of each wire connection portion 31 facing away from the bottom of the corresponding soldering groove 115 is a flat surface, which can be horizontally disposed during soldering, so as to further reduce the soldering difficulty and improve the soldering quality.

Preferably, the soldering platform 11 is plural in number, and the platform surface 111 of each soldering platform 11 is respectively fixed with a plurality of wire connection portions 31.

It should be noted that a plurality of soldering platforms 11 may be formed on the surface of the insulation body 10 of the pin header 100, and the platform surface 111 of each soldering platform 11 is respectively fixed with a plurality of wire connection portions 31. Specifically, a plurality of the soldering platforms 11, which may be in form of step-shape, are distributed over the surface of the insulation body 10, so that the process of soldering between a plurality of the wire connection portions 31 and the corresponding wires may be simultaneously performed by a plurality of mechanical soldering arms, thereby further shortening the soldering duration and improving the soldering efficiency, while ensuring the soldering quality.

In addition, such a structural arrangement can further avoid the problem of overlength of the platform surface 111 resulting from fixing all the wire connection portions 31 of the pin header 100 to a same soldering platform 11, which provides more options for the practical number and position setting of the pins 30 of the pin header 100, so as to achieve the object of reasonably arranging the wire connection portions 31 to reduce the volume of the pin header 100. Moreover, the reduction in the volume of the pin header 100 due to such a structural arrangement can further effectively reduce the length of the penetration length of the pin 30 in the insulation body 10, and reduce the difficulty in arranging the pin 30, so as to avoid the problem that the pin header 100 is scrapped as the pin 30 fractures inside the insulation body 10.

Referring to FIG. 1 again, on the basis of the foregoing embodiments, each pin 30 further comprises a plate connection portion 33, a plurality of plate connection portions 33 protrude from the surface of the insulation body 10, and end portions of a plurality of the plate connection portions 33 extend toward to a same direction.

In this embodiment, a plurality of the plate connection portions 33 all protrude from a same side surface of the insulation body 10 and are arranged in a plurality of rows on the side surface, and after extending a certain distance in a direction perpendicular to the side surface, the plate connection portions 33 in the same row all bend in the same direction and continue to extend the same distance. Understandably, such a structural arrangement can be favorable to the positioning and soldering of the plate connection portion 33 and the PCB, thereby realizing effective connection between the wire and the PCB, accomplishing the bridge function of the pin header 100, and ensuring the transmission of current or signals between the wire and the PCB.

The above description is only preferred embodiments of the present disclosure, which is not meant to limit the patent scope of the present disclosure. Any equivalent structural changes made by using the contents in the description and the drawings of the present disclosure under the inventive concept of the present disclosure, or direct/indirect application to the other related technical fields are all included in the scope of patent protection of the present disclosure.

The embodiments of the invention in which an exclusive property or privilege is claimed are defined as follows:

1. A pin header, comprising an insulation body and a plurality of pins arranged at intervals, a portion of each pin being fixed to the insulation body, each pin comprising a wire connection portion, wherein a soldering platform is formed at a surface of the insulation body, and a plurality of wire connection portions are fixed to a platform surface of the soldering platform.

2. The pin header according to claim 1, wherein a plurality of the wire connection portions are parallel to each other.

3. The pin header according to claim 1, wherein the platform surface is formed with a plurality of soldering grooves arranged at intervals, and each wire connection portion is correspondingly fixed to one soldering groove.

4. The pin header according to claim 3, wherein each wire connection portion has a rectangular section, and each wire connection portion is caught in a corresponding soldering groove.

5. The pin header according to claim 3, wherein a width of each wire connection portion is the same as a width of the corresponding soldering groove.

6. The pin header according to claim 5, wherein each wire connection portion has a rectangular section, and each wire connection portion is caught in a corresponding soldering groove.

7. The pin header according to claim 3, wherein a height of each wire connection portion is smaller than a height of the corresponding soldering groove.

8. The pin header according to claim 7, wherein each wire connection portion has a rectangular section, and each wire connection portion is caught in a corresponding soldering groove.

9. The pin header according to claim 3, wherein end surfaces of the wire connection portions facing away from a bottom of the corresponding soldering grooves are in a same plane.

10. The pin header according to claim 9, wherein each wire connection portion has a rectangular section, and each wire connection portion is caught in a corresponding soldering groove.

11. The pin header according to claim 1, wherein the soldering platform is plural in number, and the platform surface of each soldering platform is respectively fixed with a plurality of wire connection portions.

12. The pin header according to claim 1, wherein each pin further comprises a plate connection portion, a plurality of plate connection portions protrude from the surface of the insulation body, and end portions of a plurality of the plate connection portions extend toward to a same direction.
